(19) United States
(12) Patent Application Publication
(10) Pub. No.: US 2020/0227903 A1
(43) Pub. Date: Jul. 16, 2020

(54) Charging Box Unit for a Charging Station

(71) Applicant: innogy SE, Essen (DE)

(72) Inventors: Stefan Helnerus, Arnsberg (DE); Christian Müller-Winterberg, Dorsten (DE); Jürgen Waffner, Essen (DE); Florian Dembeck, Herten (DE)

(21) Appl. No.: 16/628,866

(22) PCT Filed: Jun. 25, 2018
(86) PCT No.: PCT/EP2018/066859

§ 371 Date: Jan. 6, 2020

(30) Foreign Application Priority Data
Jul. 6, 2017 (DE) 10 2017 115 098.6

(51) Int. Cl. H02G 3/18; H02G 3/16; B60L 53/16; B60L 53/31; H02J 7/00

(52) U.S. Cl. CPC H02G 3/18; H02G 3/16; H02J 7/0045; B60L 53/31; B60L 53/16

(57) ABSTRACT

The subject-matter relates to a charging box unit, comprising a base body, and a plug connection for the connection of one or more inputs and/or outputs, which is characterized in that the plug connection being arranged on an outwardly directed side of a base body of the charging box unit, wherein the plug connection is formed for connection to a corresponding socket connection of a charging station. Furthermore, the subject-matter relates to a charging station comprising an objective charging box unit.

### FIELD OF THE INVENTION

The object relates to a charging box unit comprising a base body and a plug-in connection having the features defined by the pre-amble of claim 1.

### BACKGROUND OF THE INVENTION

Charging stations are points for charging of an electric vehicle at which an owner or user of an electric vehicle connects it to the grid. In addition to publicly accessible charging points, electric vehicles are often charged by the owners or users of electric vehicles at home or at work. The installation of such charging stations plays an important role. This is because charging stations provide large electrical outputs for charging electric vehicles. Correspondingly high demands are placed on the safety of such charging stations.

In particular, the connection of a charging station to the grid is relevant to security. The installation of a charging station must therefore be carried out by an expert and cannot be carried out by an owner or user of an electric vehicle himself.

In the event of a malfunction or a defect at the charging station, even minor faults, such problems or defects must always be corrected by qualified personnel. Small errors, problems or defects can, for example, affect components of the charging station that are not related to the safety-critical electrical power supply. For example, these include errors, problems or defects at the user interface that an owner or user of an electric vehicle can use to regulate or control a charging process.

In order to avoid that an expert must always be hired for such errors, charging box units have been developed which can be arranged as a kind of module on or at the charging station. These charging box units comprise, in particular, components such as control circuits, meters, user interfaces or connection sockets for charging cables that do not relate to the grid-side electrical power supply.

The assembly or disassembly of such charging box units can be carried out by the owner or user of an electric vehicle himself. Even in the event of a fault or defect in the charging box unit, an owner or user of an electric vehicle can simply replace the faulty or defective charging box unit by himself. The use of qualified personnel is therefore no longer necessary in these cases.

### SUMMARY OF SOME EXEMPLARY EMBODIMENTS OF THE INVENTION

Normally, the charging station is permanently mounted at the installation site (e.g. on a garage wall, parking lot or on a sidewalk) and the grid-side connection can be made accordingly by means of the charging station. The charging box unit can be arranged on the fixed charging station. In the area of publicly accessible charging stations (e.g. on car parks or sidewalks), such a charging box unit may also not be detachably attached to or comprised by the charging station, in particular to reduce the risk of theft and/or vandalism. For example, to supply a charging box unit with the power required for operation, it is connected to the charging station via a dedicated connection. Such a dedicated connection may not be compatible with the connections of other charging box units and/or charging stations.

Based on this background of the presented prior art, the subject-matter has the object to provide a charging box unit which can in particular be used in an easy manner with a charging station.

This object is solved by the charging box unit comprising a plug connection for the connection of one or more input lines and/or output lines, wherein the plug connection is arranged on an outwardly directed side of a base body of the charging box unit, wherein the plug connection is formed for connection to a corresponding socket connection of a charging station.

The one or more input lines and/or output lines, for example, are present on the grid-side. The one or more input lines and/or output lines are, for example, comprised by a charging station.

The plug connection arranged on the charging box unit is connected to a corresponding socket connection of the charging station. For example, the electrical power required to operate the charging box unit is provided via the plug connection. Accordingly, the charging box unit, similar to a so-called plug-and-play module, can simply be arranged on the charging station. A sometimes time-consuming assembly or installation of the charging box unit can therefore be omitted.

A charging station (also referred to as charging point) in the sense of the present subject-matter can be understood as a charging point at the location where an owner or user of an electric vehicle connects (e.g. plugs in) the charging cable necessary for charging a battery of the electric vehicle on the grid-side.

A charging box unit in the sense of the present subject-matter can be understood, for example, as a(n) (e.g. exchangeable) element which can be arranged on a charging station (e.g. detachable arragned) and which has the inventive means. In the event of a defect, only the charging box unit needs to be replaced, and in particular not the charging station. Alternatively, such a charging box unit may be comprised by a charging station. In particular, in this case the charging box unit can be fixed (e.g. inseparable) to the charging station. This applies in particular to charging stations which are open to the public.

It has been identified that a base body of the charging box unit, the essential technology for controlling the charging box unit and/or charging station (e.g. control circuit, user interface, input/output means, sensors, processor, memory, to name a few non-limiting examples) can be comprised. For example, a keyboard or the like can be used as an input device. For example, a display or the like can be provided as an output device, so that interaction with an owner or user of an electric vehicle is enabled. A combined input/output interface is also conceivable, such as a touch-sensitive display that can display information as well as receive input from the owner or user.

A charging box unit therefore comprises the complete electrical and information and communication technology (ICT) elements, depending on the configuration of the equipment. For example, charging box units can provide the control options necessary to operate the charging station and/or provide extended functions for controlling and/or regulating the charging station. Status information or the like can also be made available to an owner or user, e.g. by means of a display device of the charging box units.

The charging box unit comprises a plug connection at the rear (e.g. a plug), via which the charging box unit may receive all the necessary input lines and/or output lines from the charging station. The charging station comprises a socket connection (e.g. a socket) corresponding to the plug connection of the charging box unit. The connection between the charging box unit and the charging station, which can be established by means of the plug connection, allows input information and output information in particular to be exchanged. Input information may include, for example, control inputs from the owner or user of the electric vehicle. Furthermore, input information can represent, for example, charging preferences of the owner or user of the electric vehicle. Input information can, for example, be entered by an owner or user of an electric vehicle via a user interface and be gathered accordingly. Output information may include, for example, information regarding a charging process, and/or query information to regulate or control a charging process. Output information may be output, for example, by means of a display device comprised by the charging box unit.

In an exemplary embodiment, the charging box unit can be detachably connected to the charging station so that the charging box unit can be arranged on or at the charging station. In particular, the charging station is fixed (e.g. immovable) at the charging station. The charging station can, for example, be located in a garage or on a garage wall. Since the charging box unit can be detachably connected to the charging station, the charging box unit is in particular interchangeable. If, for example, a defect occurs in one of the means of the charging box unit (e.g. in the display device), only the charging box unit needs to be replaced comprehensively with the defective means and not the entire charging station.

The charging box unit may, for example, comprise a housing at least partially enclosing the base body of the charging box unit. In addition, the charging box unit may comprise, for example, a control circuit for controlling the charging functions of the charging station. The control circuit, for example, is arranged in the base body and enclosed by the housing.

The plug connection of the charging box unit is arranged on an outward facing side (e.g. rear side) of the base body. The plug connection, for example, is standardized, e.g. standardized in its outer shape. Furthermore, the arrangement of contacts or contact pins and/or contact sockets comprised by the plug connection can be standardized. This opens up the possibility of further developments of charging box units according to the present invention in order to be able to continue to arrange them on an existing charging station. For example, the contacts comprised by the plug connection maybe assigned differently depending on the requirements, but their outer shape can be standardized.

According to an exemplary embodiment, it is proposed that a communication between the charging box unit and the charging station takes place via the plug connection between the charging box unit and the charging station.

It is also proposed that the plug connection is arranged on a rear side of the base body (in the received (e.g. assembled) state of the side facing the charging station), whereby the plug connection can be inserted into the corresponding plug connection of the charging station by a positive locking. The plug connection of the charging box unit may, for example, have a circumferential bulge that engages in a corresponding recess that surrounds the socket connection of the charging station.

An exemplary embodiment provides that the charging box unit can be attached to a receptacle of the charging station with the corresponding plug connection. For example, the receptacle can be a recess which is formed in such a way that the charging box unit can be attached at least partially to the recess.

For the purposes of the object, the term ‘in the received condition’ means that the charging box unit is received in the charging station receiver and the plug connection between the charging box unit and the charging station is established.

According to an exemplary embodiment, it is proposed that the bulge of the charging box unit is sealed from the corresponding recess of the charging station when the charging box unit is mounted in the recess of the charging station.

In the received condition, the seal prevents contact with energized parts. For example, a user of the charging station is not in any danger of coming into contact with such energized parts. This ensures that safety requirements are met for charging stations and thus also for charging box units that can be arranged on or at them. For sealing, for example, a seal can be arranged on the inner edge of the bulge. In addition, or alternatively, such a seal can be arranged on the inner edge of the charging station recess. The seal can be a lip seal, for example, made of a flexible and/or elastic material such as rubber.

It is also proposed that the charging box unit comprises a fixing element so that the charging box unit is fixed to the charging station in the received condition. The fixing element can be used, for example, to fix or lock the charging box unit to the charging station when being in the received condition. The fixing element may, for example, be a bulge surrounding the plug connection of the charging box unit, which, for example, the base body has (e.g. on the back of the base body). In the received condition, for example, the bulge can intervene in a corresponding recess (e.g. comprised by the charging station receptable). Alternatively or additionally, the fixing element may, for example, be comprised by the housing of the charging box unit. For example, the fixing element may be located on one of the side faces of the charging box unit housing.

Furthermore, snap-in elements such as clips can be used as fixing elements. These can, for example, snap into corresponding counterparts and fix the charging box unit to or at the charging station. Also conceivable are manually operated fixing elements, such as fixing by means of a screw or a clamping element. The fixing element ensures that the charging box unit is fixed or locked in or at the charging station receptacle when it is received by the charging station. Such a fixing element can, for example, be arranged on the back of the base body. Alternatively or additionally, the fixing element can be arranged on the housing at least partially enclosing the base body. In particular, the fixing element may be provided on one side of the housing. In an exemplary embodiment, when the charging station is in the received condition, the receptable at least partially encloses the side surface of the housing of the charging box unit. Several fixing elements can be comprised in the charging box unit.

According to an exemplary embodiment, it is proposed that the plug connection has one or more contacts, wherein at least one of the contacts transmits an electrical power and at least one other contact transmits information.

For example, control signals can be transmitted as information between the charging box unit and the charging station. Based on the control signals, a charging process of a battery in an electric vehicle, for example, can be regulated or controlled. The control signals can, for example, be generated by a control circuit (e.g. a processor with memory) comprised by the base body of the charging box unit. The control signals can, for example, be generated on the basis of information entered by an owner or user of an electric vehicle. Additionally or alternatively, the control signals can be generated at least partially automatically, for example on the basis of information acquired by one or more sensors. These sensors can, for example, be comprised by the charging box unit. For example, the sensors can be connected to the control circuit so that information collected by the sensors is processed by the control circuit and a corresponding control signal can be generated. Additionally or alternatively, status information can, for example, be transferred from the charging station to the charging box unit. Status information may, for example, be indicative of information concerning a charging process. For example, one or more pieces of status information can be displayed on a display device of the charging box unit.

It is also proposed that the following parameters are transferable via the one or more contacts:

(i) alternating electrical current;

(ii) electrical DC current;

(iii) electrical low current;

(iv) data;

(v) or a combination thereof.

Electric AC current respectively electric DC volt current is used in particular for charging batteries in electric vehicles. For example, the charging box unit can comprise a further plug connection by means of which an electric vehicle or the battery of an electric vehicle can be connected to this further plug connection (e.g. via a charging cable). If such a plug connection for charging an electric vehicle is comprised by the charging box unit, electric vehicles which require different plugs or sockets for connecting the charging cable can, for example, be connected to one and the same charging station. Merely the charging box unit has to be changed. A change of the charging box unit comprising a plug connection to connect a charging cable for an electric vehicle may also be necessary, for example, if a user of the charging station has purchased a new or additional electric vehicle and this is also to be charged using the existing charging station.

For example, the electrical low current can be used to provide the electrical energy required to operate the charging box unit.

The transmission of data, for example, enables information to be exchanged between the charging box unit and the charging station. For example, control signals can be transmitted as data as part of communication between the charging box unit and the charging station. In addition, status information can be exchanged between the charging box unit and the charging station.

According to an exemplary embodiment, it is proposed that at least one of the contacts through which an electrical power can be transmitted comprises one or more of the following input lines:

(i) 1-phase AC voltage supply line;

(ii) 3-phase AC supply line;

(iii) DC supply line;

(iv) or a combination thereof.

By means of one or more of such input lines, an AC voltage (e.g. AC 3 kW 1-phase, AC 22 kW 3-phase) or a DC voltage (e.g. DC 50 kW) in particular can be transmitted between the charging box unit and the charging station.

The 1-phase AC voltage supply line may be used, for example, for so-called home charging boxes, which can be arranged, for example, at charging points at the place of residence or at the workplace of an owner or user of an electric vehicle. For example, the 1-phase AC supply line can provide 2 kW to 5 kW, preferably 3 kW to 4 kW of electrical power.

The 3-phase AC voltage supply lines can be used, for example, for charging stations with charging box units in locations where a 3-phase electrical connection is available. Such connections are often also found in the home area. In places where electric vehicles are usually parked, such a connection may have to be installed in a dedicated manner. For example, 20 kW to 25 kW, 21 kW to 24 kW, preferably 22 kW to 23 kW electrical power can be provided by means of the 3-phase AC supply lines.

The DC supply line may be used, for example, to charge an electric vehicle with high electrical power (e.g. DC 50 kW).

The charging box unit may also comprise an AC/DC low voltage regulator (AC/DC low voltage regulator). This may, for example, be arranged in the base body of the charging box unit. By means of the AC/DC low-set converter, for example, the electrical power supplied by an AC input line can be converted into a low DC voltage. This low DC voltage can be used, for example, to power the electronic components of the charging box unit, such as the control circuit (e.g. processor and memory), user interface, display device or the like, to name but a few non-limiting examples.

This also opens up the possibility for an owner or user of an electric vehicle to initially equip the charging station used to charge the electric vehicle with a charging box unit, for example, which can be used by a single-phase AC supply line to charge the electric vehicle. If the owner or user of the electric vehicle wishes to charge his electric vehicle faster, for example, the owner or user of the electric vehicle can use another charging box unit and arrange it accordingly on the charging station, which can be used to charge the electric vehicle, for example with a 3-phase AC voltage supply line, if this can be provided by the charging station.

In an exemplary embodiment, the plug connection is de-energized if the charging box unit is not attached to the receptacle of the charging station. Thus, electrical power is only transmitted via the plug connection when the charging box unit is arranged at the charging station. In order to enable at least semi-automatic switching on of an electrical power, a pushbutton or the like, for example, can be comprised by the plug connection. The pushbutton is actuated, for example, when the charging box unit is attached to the charging station receptacle. The pushbutton may, for example, be a switch by means of which, for example, the current flow from a supply line from the charging station to the charging box unit can be switched on or off.

The plug connection may, for example, comprise one or more output lines from the charging box unit to the charging station. These one or more output lines can be used, for example, to transmit information, e.g. for communication between the charging box unit and the charging station. The line used for communication can also be designed as a power supply line. By means of a combined input and output line, bidirectional communication can take place between the charging box unit and the charging station. In an exemplary embodiment, a supply line of the plug connection, which is intended for the transmission of an electrical power (e.g. by means of alternating voltage or direct voltage), can be used simultaneously for the transmission of information. For this purpose, for example, the electrical power can be superimposed with a communication signal, e.g. by means of a corresponding modulation of the communication signal.

In an exemplary embodiment, the charging box unit comprises a connection for connecting a charging cable, wherein electrical power can be provided at the connection via the plug connection. For example, electrical power can be provided in the form of alternating electrical current, direct electrical current and low electrical current. Electric alternating current can be provided, for example, via the 1-phase alternating voltage supply line or the 3-phase alternating voltage supply lines. Electrical DC current, for example, can be provided via the DC voltage supply line.

It is also proposed that the plug connection is mounted as a floating plug connection so that in the event of (e.g. minor) movements in a received condition of the charging station, the plug connection of the charging box unit stays connected to the plug connection of the charging station. The plug connection can be moved in the direction of two degrees of freedom in relation to the plane formed by the flat surface of the base body in which the plug connection is arranged. The plug connection, for example, is a floating plug connection mounted in relation to the base body.

For example, a smaller movement in the sense of the present subject-matter corresponds to a relative movement in the direction of two degrees of freedom in the longitudinal and/or transverse direction of the plug connection (e.g. plug) of the charging box unit relative to the socket connection (e.g. socket) of the charging station, the relative movement being smaller than the length and/or width of the plug connection of the charging box unit.

According to an exemplary embodiment, it is proposed that an anti-theft device is provided so that a charging box unit attached to the charging station can no longer be detached from the outside. This is particularly recommended when arranging such charging box units on charging stations that are accessible to the public.

Further, it is proposed that the anti-theft device should have a snap-in element accessible from the inside of the charging station, which, when actuated, allows the charging box unit to be released from the receptacle of the charging station.

For example, the anti-theft device that the charging box unit cannot be detached from the outside when the charging box unit is arranged on or at the charging station. A simple removal of the charging box unit from the outside of the charging station is therefore no longer possible. In order to make it possible to replace a charging box unit attached to or at the charging station, the anti-theft device, for example, can be unlocked as explained above. For example, this can be done using a suitable adapter or the like which, for example, engages in an opening provided for unlocking the anti-theft device. Additionally or alternatively, the charging station or the housing of the charging station can be opened, e.g. by means of an inspection opening or the like. For example, the anti-theft device can be unlocked from the inside of the charging station, e.g. manually.

According to an exemplary embodiment, it is proposed that the charging box unit can be fixed to the charging station by means of the plug connection when it is in the received condition.

Alternatively, the charging box unit is fixed to the charging station by means of the plug connection when it is in the received condition. For this purpose, the plug connection (e.g. on the part of the charging box unit and/or on the part of the charging station) may have a snap-in element (e.g. a clamping element, a hook-like element or the like). When connecting the plug connection, the snap-in element snaps into a correspondingly designed counterpart by means of a holder for the charging box unit in the holder of the charging station, so that the charging box unit can be fixed or fixed to the charging station by means of the plug connection.

The object is also solved by a charging station, the charging station comprising at least one objective charging box unit.

In the following, the subject-matter is explained in more detail using a drawing showing examples of execution. Show in drawing:

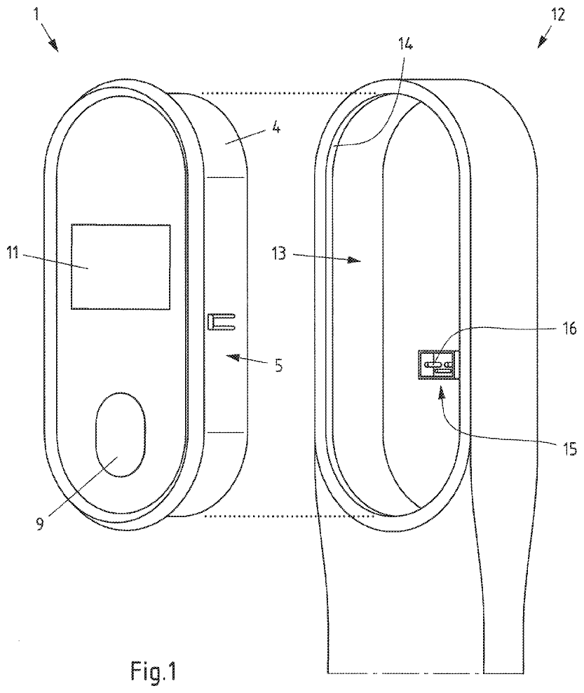

FIG. 1 a view of a charging box unit and a charging station according to an exemplary embodiment;

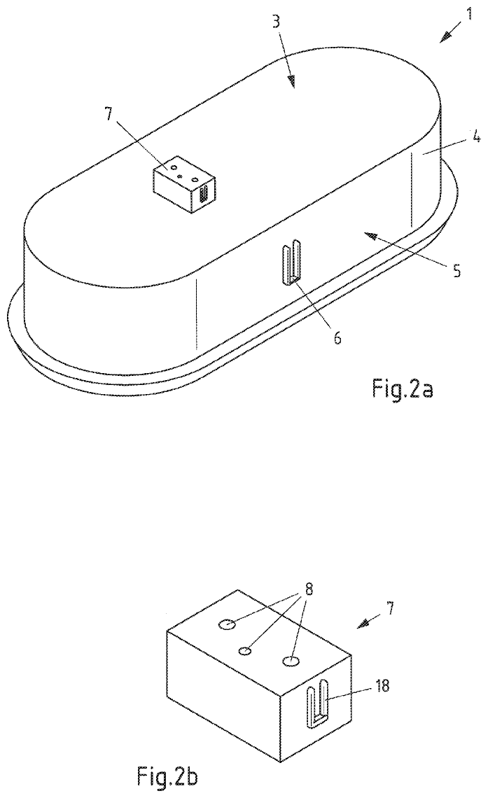

FIG. 2a a view of a charging box unit according to an exemplary embodiment;

FIG. 2b an enlarged view of the plug of the charging box unit according to FIG. 2a according to an exemplary embodiment;

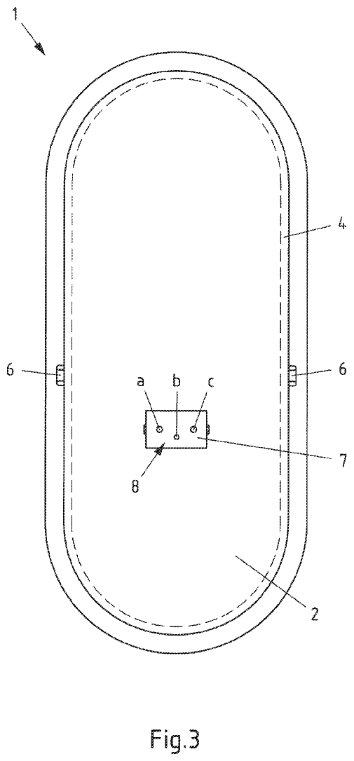

FIG. 3 a rear view of a charging box unit with a base body and a housing according to an exemplary embodiment; and

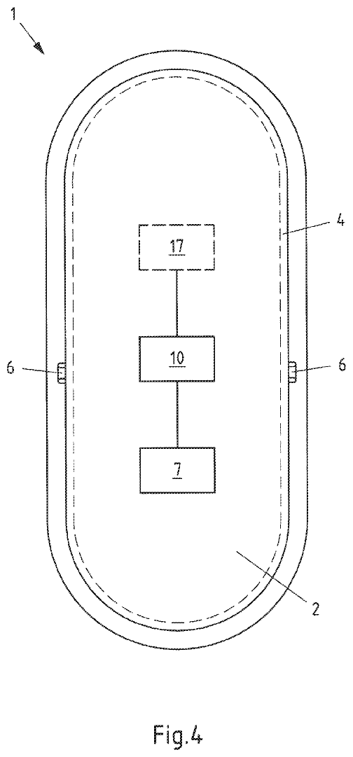

FIG. 4 a schematic view of a base body with a housing of a charging box unit according to an exemplary embodiment.

### DETAILED DESCRIPTION OF SOME EXEMPLARY EMBODIMENTS OF THE INVENTION

FIG. 1 shows a schematic view of a charging box unit and a charging station according to an exemplary embodiment.

The charging box unit 1 comprises a base body 2, and a plug connection 7 (not visible in FIG. 1), there being a plug 7, for the connection of one or more input lines and/or output lines on the grid-side. The plug connection 7 is arranged on an outwardly directed side of the base body 2 (not visible in FIG. 1). Plug connection 7 is designed for connection to a corresponding socket connection 15, there being a socket 15, of a charging station 12.

The charging box unit 1 can be arranged in a receptacle 13 of the charging station 12, which is designed in accordance with the rear side of the charging box unit 1 or the rear side shape (e.g. at least partially comprising the side surface 5 of the housing 4 and the base body 2 forming the rear wall) of the charging box unit 1. This possibility is marked schematically by the two dashed lines between the charging box unit 1 and the charging station 12 in FIG. 1. The charging box unit 1 can at least partially be attached to the receptacle 13 of the charging station 12. The shape of the recess formed by the receptacle 13 of the charging station 12 essentially corresponds to the shape of the charging box unit 1, so that the base body 2 and the housing 4 of the charging box unit 1 can be positively interlocked in the receptacle 13. When the charging box unit 1 is mounted in the receptacle 13 of the charging station 12, the side surface 5 of the housing 4 of the charging box unit 1 is at least partially enclosed by the receptacle 13.

The receptacle 13 of the charging station 12 comprises the plug connection corresponding to plug 7 of charging box unit 1, socket 15. Plug 7 of charging box unit 1 can be connected to socket 15 of charging station 12.

The receptacle 13 comprises a seal 14. The seal 14 is a lip seal which is arranged on the inner edge of the receptacle 13 facing the opening of the receptacle 13. Alternatively or additionally, the seal 14 can be arranged on the side surface 5 of charging box unit 1, for example. For example, the seal 14 is arranged circumferentially along the side face 5 of the housing. The seal 14 ensures that the charging box unit 1 is sealed against the charging station in the received condition. The seal 14 prevents the penetration of dirt (e.g. dust, dirt or the like).

On the front side, the charging box unit 1 has a connection 9 for a charging cable of an electric vehicle. If an electric vehicle is connected to connection 9 by means of a charging cable, this connection can be used to provide 9 electrical power, which is provided on the grid-side via charging station 12 and the plug connection existing between charging box unit 1 and charging station 12 (consisting of plug 7 and socket 15). A battery in an electric vehicle, for example, can be charged accordingly. Alternatively, the electric vehicle can be connected directly to the charging station 12 via a charging cable. In this case, the charging station 12 has an appropriate connection for the charging cable.

The charging box unit 1 comprises a display device 11. The display device 11 may be designed as a touch-sensitive display so that input from a user or owner of an electric vehicle can be gathered. In this case, the display device 11 comprises a user interface.

Additionally or alternatively, charging box unit 1 can comprise a dedicated user interface for gathering user input.

The user interface may be used, for example, to gather input from an owner or user of an electric vehicle. For example, the owner or user can start and/or stop the charging process of an electric vehicle connected to charging station 1 by entering a corresponding input into the user interface.

FIG. 2a shows a perspective view of a charging box unit according to an exemplary embodiment.

From the rear side 3 of the base body 2 of the charging box unit 1, a plug connection in the form of a plug 7 protrudes. The plug 7 can engage in a corresponding socket 15 of a charging station 12, so that communication between the charging box unit and the charging station, for example, and/or electrical power from a mains-side connection of the charging station 12 can be transmitted via the plug connection established between charging box unit 1 and charging station 12 via the connection.

On the side surface 5 of the housing 4, the charging box unit 1 has at least one fixing element 6, for example a locking lug. The fixing element is formed in such a way that the charging box unit 1 is fixed in the received condition of the charging box unit 1 in a receptacle 13 of the charging station 1. Accordingly, the charging box unit 1 cannot be detached from the receptacle 13 of the charging station 1 without loosening the fixing element 6. For example, a further fixing element 6 may be arranged on the side surface of charging box unit 1 opposite the side surface with fixing element 6. The use of an additional fixing element 6 can strengthen the fixing of the charging box unit 1 to the charging station 12 when it is in the received condition.

FIG. 2b shows an enlarged view of the plug of the charging box unit according to FIG. 2a according to an exemplary embodiment.

Plug 7 comprises one or more contacts, which can be designed as contact pins, for example, or alternatively as contact sockets 8. For example, an electrical power can be transmitted via at least one of the contacts. Additionally or alternatively, information can be transmitted via at least one (further) of the contacts. By transmitting the information, for example, communication can take place between charging box unit 1 and charging station 12. For example, communication may comprise control signals. One or more control signals can, for example, be generated by a control circuit, e.g. based on information gathered by user input.

Plug 7 has a snap-in element 18 on at least one of the side faces. The snap-in element 18 can, for example, engage in a corresponding counterpart which, for example, is comprised by socket 15 of charging station 1. The snap-in element 18 allows, for example, the charging box unit 1 to be fixed to the charging station 12 via the plug connection that can be established between the charging box unit 1 and the charging station 12.

FIG. 3 shows a rear view of a charging box unit with a base body and a housing according to an exemplary embodiment.

The plug 7, which protrudes from the base body, is arranged on the base body 2.

The charging box unit 1 comprises a housing 4 at least partially enclosing the base body 2. One or more fixing elements 6 may be arranged in the side surface 5 of the housing comprising the base body 2. The fixing elements 6 can, for example, be located in the lower third of the side surface 5 of the housing 4, which is oriented towards the rear of the charging box unit 1. In this lower third, it is ensured that a charging box unit 1, which is attached to a receptacle of the charging station 12, is held in a torsion-proof position and secured against unintentional removal.

The plug 7 comprises three contact sockets 8, which are marked with the reference numerals 8a, 8b, 8c. Contact pins 16 (e.g. of socket 15 according to FIG. 1) can engage in these contact sockets 8. These contact sockets 8a to 8c can be used, for example, to connect input and/or output lines from or to charging station 1 to charging box unit 1 via plug 7. For example, connector 7 comprises one or more connecting lines to a control circuit 10, as shown schematically in FIG. 4.

FIG. 4 shows a schematic rear view of a base body with a housing of a charging box unit according to an example.

A plug 7, a control circuit 10 and a user interface 17 connected to a display device (e.g. display device 11 according to FIG. 1) are shown in the base body 2 of the charging box unit 1. The user interface 17 is optional, since the user interface may, for example, be covered by a display device, or it is not mandatory. For example, a user interface could also be provided via a user interface connected to the charging station. For example, a display device with a user interface is a touch-sensitive display.

The user interface 17 can be used, for example, to gather the input of an owner or user of an electric vehicle. For example, the user interface can be used to set target settings in connection with a charging process for a battery in an electric vehicle. As non-limiting examples, the setting of a charge state (e.g. full charging, percentage charging, charging for the duration of a predetermined time, charging for a certain amount of money, etc.) may be mentioned at this point.

The control circuit 10 is usually a microprocessor that can perform a variety of functions. Control circuit 10, for example, is connected to plug 7 and the optional user interface 17. In addition, the control circuit can be connected to a display device (e.g. display device 11 of charging box unit 1 according to FIG. 1).

The control circuit 10 can, for example, have communication means to communicate with a central control unit or an electronic device (e.g. smartphone, tablet or the like). In this case, communication can take place via an air interface, for example. Thus, the control circuit 10 can, for example, receive parameters for the setting of a charge state via the air interface. The control circuit 10 can also determine, for example, the state of charge of a battery of an electric vehicle connected to charging box unit 1 or to a charging station 12. Depending on a comparison result determined by the control circuit 10, for example, a charging process can be started. Furthermore, the control circuit can, for example, determine status information of a current charging process. Status information can, for example, comprise actual states of a connected battery of an electric vehicle. This determined status information can, for example, be displayed by a display device (e.g. display device 11 according to FIG. 1). Additionally or alternatively, the determined status information can be transmitted to a central controller and/or an electronic device. The transmission can, for example, take place via the means of communication, e.g. via an air interface.

The example embodiments of the present invention described in this specification and the optional features and characteristics listed in each case shall also be understood to be disclosed in all combinations with each other. In particular, the description of a feature comprised by an exemplary embodiment—unless explicitly stated otherwise—should not be understood to mean that the feature is indispensable or essential for the function of the exemplary embodiment. The sequence of the method steps described in this specification in the individual flow charts is not mandatory, alternative sequences of the method steps are conceivable. The method steps can be implemented in different ways, e.g. an implementation in software (by program instructions), hardware or a combination of both to implement the process steps is conceivable.

Terms used in patent claims such as “comprising”, “having”, “including”, “containing” and the like do not exclude other elements or steps. The expression “at least in part” covers both the case “in part” and the case “in full”. The wording “and/or” should be understood as meaning that both the alternative and the combination should be disclosed, i.e. “A and/or B” means “(A) or (B) or (A and B)”. The use of the indefinite article does not exclude a plurality. A single device can perform the functions of several units or devices mentioned in the patent claims. The reference numerals indicated in the claims are not to be regarded as limitations of the means and steps used.

### LIST OF REFERENCE NUMERALS

1 charging box unit
2 base body
3 rear side
4 housing
5 side surface
6 fixing element
7 plug
8 contact sockets
9 Connection for charging cable
10 control circuit
11 display device
12 charging station
13 receptacle
14 seal
15 socket
16 contact pins
17 user interface
18 snap-in element

1. A charging box unit comprising:
a base body, and
a plug connection for the connection of one or more inputs and/or outputs,
characterized in that
the plug connection being arranged on an outwardly directed side of a base body of the charging box unit, wherein the plug connection is formed for connection to a corresponding socket connection of a charging station.

2. The charging box unit according to claim 1, wherein communication takes place between the charging box unit and the charging station via the plug connection.

3. The charging box unit according to claim 1, wherein the plug connection is arranged on a rear side of the base body, the plug connection being positively interlocking in the corresponding socket connection of the charging station.

4. The charging box unit according to claim 1, wherein the charging box unit is receivable in a receptacle, which has the corresponding plug connection of the charging station.

5. The charging box unit according to claim 4, wherein the charging box unit is sealed with respect to the charging station when the charging box unit is attached to the receptacle of the charging station.

6. The charging box unit according to claim 4, wherein the charging box unit comprises a fixing element so that the charging box unit is fixed to the charging station in a received condition.

7. The charging box unit according to claim 1, wherein the plug connection has one or more contacts, wherein an electrical power is transmitted via at least one of the contacts and information is transmitted via at least one further one of the contacts.

8. The charging box unit according to claim 7, wherein the following parameters are transferable via the one or more contacts:
(i) alternating electrical current;
(ii) electrical DC current;
(iii) electrical low current;
(iv) data;
(v) or a combination thereof.

9. The charging box unit according to claim 7, wherein at least one of the contacts through which an electrical power is transferable comprises one or more of the following input lines:
(i) 1-phase AC voltage supply line;
(ii) 3-phase AC supply line;
(iii) DC supply line;
(vi) or a combination thereof.

10. The charging box unit according to claim 1, the charging box unit comprising a connection for connecting a charging cable, wherein electrical power is providable at the connection via the plug connection.

11. The charging box unit according to claim 1, the plug connection being a floating plug connection so that, in the event of movements in a received condition of the charging box unit at the charging station, the plug connection of the charging box unit stays connected to the socket connection of the charging station.

12. The charging box unit according to claim 1, wherein an anti-theft device is provided so that the charging box unit attached to the receptacle of the charging station cannot be detached from the outside.

13. The charging box unit according to claim 12, the anti-theft device having a snap-in element which is accessible from an inside of the charging station and, when actuated, enables the charging box unit to be released from the receptacle of the charging station.

14. The charging box unit according to claim 1, the charging box unit being fixable to charging station in the received condition by means of the plug connection.

15. A charging station comprising at least one charging box unit according to claim 1.
